(19) United States
(12) Patent Application Publication
(10) Pub. No.: US 2016/0285812 A1
(43) Pub. Date: Sep. 29, 2016

(54) METHOD OF ISSUING MESSAGES OF A MESSAGE QUEUE AND A MESSAGE ISSUING DEVICE

(71) Applicant: XINYU XINGBANG INFORMATION INDUSTRY CO., LTD., Xinyu City (CN)

(72) Inventors: Xiaohong YAO, Xinyu City (CN); Jiajian ZHOU, Xinyu City (CN)

(21) Appl. No.: 15/008,806

(22) Filed: Jan. 28, 2016

(30) Foreign Application Priority Data
Mar. 24, 2015 (CN) 201510130179.7

(51) Int. Cl. H04L 12/58

(52) U.S. Cl. CPC H04L 51/26

(57) ABSTRACT

Disclosed is a method of issuing messages in a message queue. The method comprises: (a) receiving a request of entering a message into the message queue, obtaining parameter information of the message, determining priority of the message according to the parameter information of the message, and inserting the message into the message queue according to priority of the message; (b) issuing messages in the message queue sequentially according to the priority of each message. The method can optimize the timing of dequeueing message from the message queue, ensure a quick processing of the critical transaction, avoid prolonged delay of the message with lighter weight, reduce the risk of system application, and improve user's real-time interactive experience.

### FIELD OF THE INVENTION

The present application relates to computer network communication, particularly to a method of issuing messages of a message queue and a message issuing device.

### BACKGROUND OF THE INVENTION

Message queue is a container for storing message during message transmission. A message queue manager acts as an intermediary when a message is relayed from source to target. Message queue is provided mainly for the purpose of providing the routing and make sure the transmission of the message. If a failure occurs in sending a message, the message queue will keep the message till it is transferred successfully.

Conventionally, message queue issues message according to a customized way of “first in first out (FIFO)” in a queue. Then, a new way is proposed in which a queue and a stack can be converted to each other, so that message can be issued in either “FIFO” manner or “last in first out (LIFO)” manner as necessary. However, these methods cannot meet business requirement on a real-time priority of a queue when issuing messages. Further, a way is proposed in which a queue is stored into a data table based on features of a relational database, and issuing sequence is processed through a sort command to issue messages in sequence. However, this way also has defects in that, if a congestion occurs in an issuing channel and a sequence in the data table cannot be issued from the queue, the new loaded messages cannot apply priority, and have to wait until issuing of the blocked queue is completed, so that the new loaded message can be issued, rendering a delay of message issuance.

### SUMMARY OF THE INVENTION

According to an aspect of the present application, a method of issuing messages of a message queue is provided, which comprises: receiving by a processor a request of entering a message into the message queue through an interface, obtaining by the processor parameter information of the message, determining by the processor priority of the message according to the parameter information of the message, and inserting by the processor the message into the message queue according to the priority of the message; issuing by the processor messages of the message queue sequentially according to the priority of each message through the interface.

The method can optimize the timing of issuing messages of a message queue, so as to ensure that important transactions can be quickly handled and avoid big delay of issuance of messages having lighter weight, thus reducing the risk of system application and improving real-time interactive experience for users.

In some embodiments, the message queue is stored in a buffer of a server, and the request of entering the message into the message queue is received via an application programming interface of the server. The interface can connect with other application program, thus providing a wider range of usage compared with conventional method of writing data into database or medium By using such an interface, it is not necessary to access source code or understand details of internal operation scheme of other applications, which makes operations simple and swift.

In some embodiments, when a failure occurs in issuing a message of the message queue, the priority of the message is updated by the processor according to the current weight and time factor of the message. The message is inserted into the message queue by the processor according to the updated priority, and then messages in the message queue are issued sequentially according to the current order of the priority through the interface.

In some embodiments, the priority of the message is determined synthetically by the processor by the processor according to the weight of the message and the time factor of the message. Through various operations of the weight and time factor of the messages, various sequences of priorities can be obtained so as to facilitate a wider range of selection of sequences for issuing messages.

In some embodiments, the priority of the message is determined by a product of the weight of the message and the time factor of the message, while in other embodiments the priority can be obtained using power or function operation depending on different situation or different emphasis on different parameters. Modification of the parameters or the relationship thereof is also available for the skilled in the art.

In some embodiments, time factor of each message is updated by the processor every time after a message of the message queue is issued. Such an update of the time factor ensures that the priority of the message will increase with the time, so that all messages can dequeue timely.

In some embodiments, a priority of each message in the message queue is updated every time after a message is issued. Such an update can meet the varying requirements of business transactions.

In some embodiments, the message is packaged and converted to a recognized pushing entity by the processor and then submitted to an operating gateway so that the pushing entity can be issued through the operating gateway.

In some embodiments, the status information of the issued message is stored into a message status database. Further, the message queue in a buffer may be monitored by the processor through a thread, and each message is issued according to the priority thereof.

According to another aspect of the application, a message issuing device is provided. The device comprises: a priority determining unit comprising a processor and configured to receive a request of entering a message into a message queue, obtain parameter information of the message, determine priority of the message according to the parameter information of the message, and insert the message into the message queue according to the priority of the message; a message issuing unit comprising an interface and configured to issue each message in the message queue according to the priority sequentially.

According to the above method and the device, the commercial demand of flexible real-time prioritization can be fulfilled. The prioritization is determined in consideration of various factors such as message weight and time of pushing into stack, etc. When messages enter a queue, weight statement is received and then the messages are inserted into appropriate positions in the queue according to their push time. The priority is updated upon the updating of the time factor of each message after each issuance of the message. Thus, the timing of issuing messages from message queue can be optimized so that critical transactions can be quickly processed while long period of delay for messages with small weight can be avoided, which reduces the risk of system application and improves user's real-time interactive experience.

### BRIEF DESCRIPTION OF THE DRAWINGS

FIG. 1 is a flow diagram for a method of issuing a message for a message queue of one embodiment of the present invention;

FIG. 2 is a structural schematic diagram for a message issuing device of one embodiment of the present invention.

### DETAILED DESCRIPTION OF THE INVENTION

A computer system for issuing message of a message queue according to the present invention may be implemented via personal computers, mobile devices, televisions, appliances, or the like.

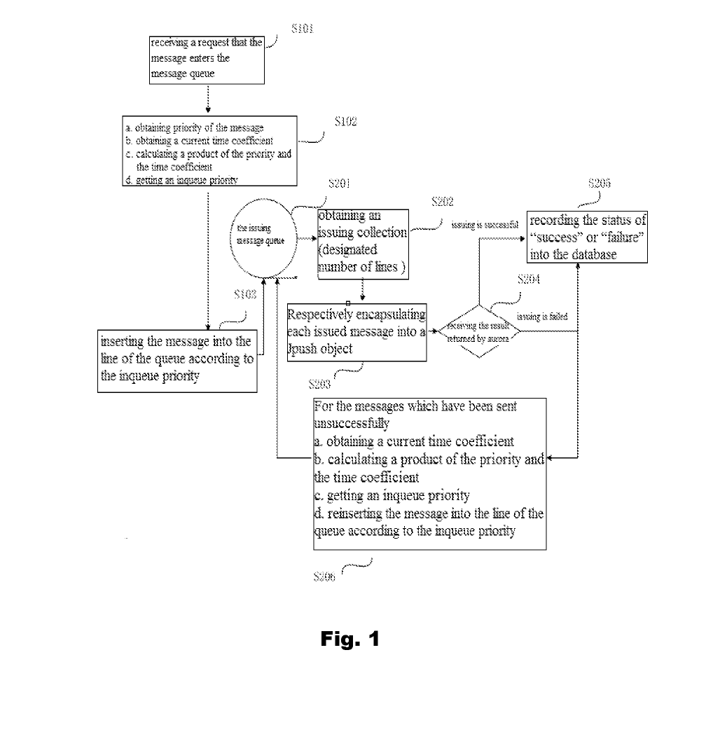

Various implementations of the invention will now be described. The following description provides specific details for a thorough understanding and an enabling description of these implementations. A skilled in the art will understand that the invention may be practised without some details disclosed herein. Moreover, some well-known structures or functions will not be illustrated or described to their details to avoid unnecessarily obscuring the substantive features which are embodied in the relevant description of various implementations. Also, the terminology used throughout the whole description is intended to be interpreted in its broadest reasonable manner, though it may be used in conjunction with certain specific embodiments of the invention. FIG. 1 schematically shows a flow diagram for a method of issuing messages of a message queue according to an embodiment of the present invention. As shown in FIG. 1, the method of the embodiment comprises a forward flow process and a self-cycle process. Specifically, the method comprises:

Process 1: receiving a request that a message will enters into a message queue, obtaining parameter information of the message, determining a priority of the message according to the parameter information of the message, and inserting the message into the message queue according to the priority of the message. In particular, the process comprises:

S101: receiving a request that a message will enter a message queue

A message issuance queue is stored in a public buffer. According to the embodiment, an API (Application Programming Interface) can be provided to receive enqueue requests. API comprises some predefined functions so as to provide applications and developer with capability of accessing to a set of routines based on a software or hardware without processing with the source code or understanding the details of internal working mechanism of the routines. APIs in this embodiment receive an enqueue request passed from the application unit. The following is an example of function definitions for receiving an application unit:

// enqueuing interface
public String push(PushVO pushVO);
// Asynchronously detecting whether the client receives the push
public int checkClientPush(String msgIdStr);

In addition, the message enqueue can also be carried out by using conventional methods of database or medium writing, and then using a separate program traversal to issue the enqueue message.

The above message makes a message weight statement when requesting enqueue and requests the queue to provide a message entity. The message entity comprises information of receiver of the message, content to be issued and an optional weight value. The message queue receives an enqueue request of the message. Weight is assigned by the application project unit itself, and the condition of the assignment is also specifically set by the application project unit according to specific transaction. By using a time factor, message having lower weight can have a chance to obtain a higher priority with respect to messages having higher weight, thus avoiding a problem of congestion of messages having low weight, which is called “low weight jam”.

S102: obtaining weight and a current time factor of the message (a period of the message in the queue), determining a priority of the message based synthetically on the weight and the time factor of the message, e.g., by the following formula:

Priority of the message=weight of the message*the current time factor of the message.

The above formula schematically reflects the priority of message with a relatively simple calculation, which facilitates an intuitive observation of priorities and election of a higher priority. For a skilled in the art, according to different situations and different attention to respective parameters, powers operation or functions and other operation method may be used in addition to the multiplication discussed above. Also, parameters of the above formula or the relationship of the parameters may be modified or calculated in other way. All these modifications are within the scope of protection of the invention.

S103: inserting the above messages to the message queue buffer according to the order of the priority thereof to form the message queue of the messages to be issued. For example, a message having higher priority is inserted into a position in the buffer where the message will be sent out earlier.

Process 2: issuing messages of the message queue according to their priorities.

S201: messages enter the queue continuously in the above steps S104, forming a message queue of the messages to be issued.

S202: monitoring message queue buffer with a thread, and when it is observed that messages to be issued exists in the message queue buffer, getting a collection of the messages to be issued (specifying number of rows of the messages to be issued) according to the priority of the messages.

S203: packaging message entities of the enqueue messages. The packaging is conducted by combining constraints of the message entity applied on third party service providers (such as receiving element name, transaction identification code and device identifier, etc., of service providers) with general properties of the transactions (for example, transaction event ID codes contained in the message body: logoff, notification and form, etc.), so as to convert the message to a push entity being identifiable to application software for message push. In this embodiment, the message push is conducted by means of JPush (Aurora push) which is a conventional developers-oriented and free third party message push service. The push entity is submitted to a JPush gateway for the push service.

An example of an implementation for packaging the above message entity is as follows:

```
    PushVO pushVO = new PushVO( );
    PushMsg pushMsg = new PushMsg( );
    // Communication tools type Qiuying Constants
    pushMsgVO.setMesType(QiuyingConstants.
    MESSAGE_TYPE_NOTIFICATION);
    pushMsgVO.setPushStatus(QiuyingConstants.PushState.
MSG_PUSH_STATUS_PUSHING);
    pushMsgVO.setId(id);
    // JpushUtils is an identification tool class of Aurora through which
the corresponding identification code complying with the Aurora format
class is obtained.
    pushMsgVO.setSendNo(String.valueOf(jPushUtils.getSendNo( )));
    // extras is a third-party adapting constructor which fully satisfies
each of the third-party extensions.
    pushMsgVO.setExtras(extras);
```

The following is an example of codes for carrying out message pushing by the above push entities:

pushMsgVO.setLevel(3);
BeanUtils.copyProperties(pushMsg, pushMsgVO);
JPushParams params = new JPushParams( );
params.setSendNo(Integer.parseInt(pushMsgVO.getSendNo( )));
params.setReceiverType
(getReceiverType(pushMsgVO.getReceiveType( )));
params.setReceiverValue(pushMsgVO.getReceiverId( ));
pushVO.setPushMsg(pushMsg);
pushVO.setParams(params);
pushVO.setExtras(extrasMap);
String result = jPushService.push(pushVO);

S204: receiving results provided by the service provider's transactions and returned by the Aurora gateway.

S205: Determining whether the message is issued successfully according to the results returned through the Aurora gateway. The feedback results will be recorded into the database for future reference whether or not the issuing is success.

S206: when issuing a message from the message queue is failed, updating the priority of the message according to the current parameter information of the obtained message, and reinserting the message into the message queue according to the updated priority.

Repeating steps S201 to S206 to issue each message in the message queue according to its current priority. Wherein, time factor of each message in the message queue is updated every time after issuing a message. Further, priority of each message in the message queue is updated every time after issuing a message. The message queue buffer is monitored through a procedure to see if there is a message to be issued, and the message will be issued until the no message is left in the message queue.

The following is an exemplary program code for determining the time factor when performing the above enqueue action:

msgTemplate.add(“MsgSets”,
pushVO, (new date( ).getSeconds( )+1)*pushVO.getPushMsg( ).
getLevel( ));

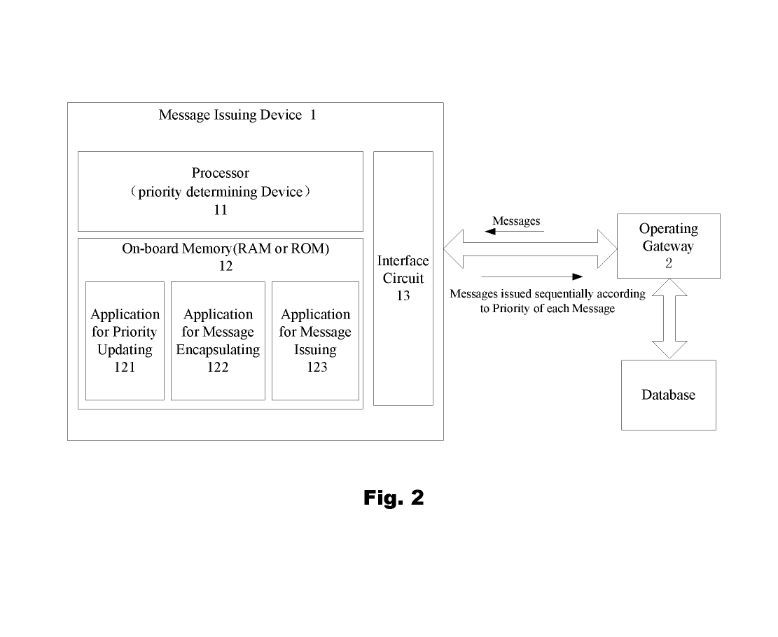

FIG. 2 schematically shows a structural block diagram of a message issuing device 1 of an embodiment of the present application. As shown in FIG. 2, the message issuing device 1 comprises a processor 11 which carries out an application for implementing a priority determining unit. The priority determining unit is configured to receive a request of a message entering a message queue, obtain parameter information of the message, determine priority of the message according to the parameter information of the message, and insert the message into the message queue according to priority of the message.

The processor 11 is provided with an on-board memory 12 (e.g., RAM and ROM) in which three applications, i.e. an application for priority updating 121, an application for message encapsulating 122 and an application for message issuing 123 are configured, and an interface circuit 13.

Specifically, the application for priority updating 121 is configured to, when message issuing from the message queue is failed, update the priority of the message according to the obtained current weight and time factor of the message and reinsert the message into the message queue according to the current priority. The application for message encapsulating 122 is configured to package the message, convert the packaged message to a recognizable push entity, submit the push entity to an operating gateway 2, and issue the push entity through the application for message issuing 123. The application for message issuing 123 communicates with an operating gateway 2 to issue messages in the message queue sequentially according to the priority of each message through the interface circuit 13.

The above are only some embodiments of the present invention. One skilled in the art will readily appreciate that various variations and modifications can be made without deviating from the scope of the embodiments, which fall within the protection scope of the present invention. For example, according to different situations and different emphasis on different parameters, the application also can use power operation or functions and other operation methods in addition to multiplication. For the skilled in the art, the application can also modify the parameters of the formula in this invention, or make other modifications or operations on the relationship between the parameters. These all belong to the inventive conception of the present application, and thus are within the scope of protection of this invention.

1. A method of issuing messages from a message queue, comprising:
(a) receiving by a processor a request of entering a message into the message queue through an interface, obtaining by the processor parameter information of the message, determining by the processor priority of the message according to the parameter information of the message, and inserting by the processor the message into the message queue according to the priority of the message;
(b) issuing by the processor messages of the message queue sequentially according to the priority of each message through the interface.

2. The method of claim 1, wherein the message queue in step (a) is stored in a buffer of a server, the request of entering the message into the message queue is received via an application programming interface of the server.

3. The method of claim 2, wherein in step (b), when issuing the message of the message queue is failed, the processor updates the priority of the message according to the current weight and time factor of the obtained message, reinsert the message into the message queue according to the updated priority, and issue each message in the message queue sequentially according to its updated priority through the interface.

4. The method of claim 3, wherein the priority of the message is determined by a product of the weight of the message and the time factor of the message.

5. The method of claim 4, wherein time factor of each message in the message queue is updated every time by the processor after issuing the message.

6. The method of claim 5, wherein a priority of each message in the message queue is updated after issuing a message.

7. The method of claim 2, wherein step (b) comprises: using the processor to package the message, convert the packaged message to a recognized pushing entity, submit the pushing entity to an operating gateway, and issue the pushing entity through the operating gateway.

8. The method of claim 2, wherein step (b) further comprises:
storing status information of the issued message into a message status database stored in a storage medium of the server; and/or
monitoring the message queue in the buffer by the processor through a thread, and issuing each message by the processor according to a priority of each message in the message queue through the interface.

9. A message issuing device, comprising:
a priority determining unit (11) comprising a processor, configured to receive a request of entering a message into a message queue, obtain parameter information of the message, determine priority of the message according to the parameter information of the message, the message being inserted into the message queue according to the priority by the processor;
a message issuing unit (12) comprising an interface circuit, configured to issue messages in the message queue sequentially according to the priority of each message, and
said processor being provided an on-board memory for storing applications and message queue.

10. The message issuing device of claim 9, wherein the applications comprises:
application for priority updating, configured to, when issuing the message from the message queue is failed, update the priority of the message according to the obtained current weight and time factor of the message and reinsert the message into the message queue according to the current priority,
application for message encapsulating, configured to package the message, convert the message to a recognized pushing entity, and submit the entity to an operating gateway so that the pushing entity is issued through the operating gateway, and
application for implementing message issuing, configured to communicate with operating gateway through the interface circuit to issue messages in the message queue sequentially according to the priority of each message.
